(19) United States
(12) Patent Application Publication
(10) Pub. No.: US 2011/0122141 A1
(43) Pub. Date: May 26, 2011

(54) MAP DATA RECORDING DEVICE, MAP DISPLAY, MAP DATA RECORDING METHOD, MAP DISPLAY METHOD, MAP DATA RECORDING PROGRAM, MAP DISPLAY PROGRAM, AND RECORDING MEDIUM

(75) Inventors: Shunsaku Toyoda, Kanagawa (JP); Ippei Nambata, Saitama (JP); Hajime Adachi, Saitama (JP)

(73) Assignees: PIONEER CORPORATION, Kanagawa (JP); INCREMENT P CORPORATION, Kanagawa (JP)

(21) Appl. No.: 12/997,409

(22) PCT Filed: Jun. 13, 2008
(86) PCT No.: PCT/JP2008/060906

§ 371 Date: Feb. 9, 2011

(51) Int. Cl. G09G 5/39; G06F 17/30

(52) U.S. Cl. 345/531; 707/693; 707/E17.018

(57) ABSTRACT

In a map data recording device (100), a setting section (104) sets a group by combining parcel data so that the total amount of data is within the upper limit value acquired by an upper limit data amount acquiring section (102) or the total number of pieces of data is within the upper limit number of pieces acquired by an upper limit number-of-pieces of data acquiring section (103). A compression section (105) then groups the parcel data for compression and a recording control section (106) records it on a recording section (101). Further, in a map display (110), a reading section (112) reads the parcel data in a group unit from the recording section (101) and extends the parcel data read by an extension section (113). A display control section (114) then controls a display section (111) and selects parcel data included in a display range from the extended parcel data to display it on the display section (111).

### TECHNICAL FIELD

The present invention relates to a map-data recording device, a map displaying device, a map-data recording method, a map displaying method, a map-data recording program, a map displaying program, and a recording medium that combine and compress data.

### BACKGROUND ART

Conventionally, technology has been suggested in which electronic data that includes map data, data for route search, index data, etc., that are at least partially compressed and stored on a CD-ROM (see, for example, Patent Document 1 below). In this technology, the electronic data are read out from the CD-ROM by a reading device, and whether the electronic data have been compressed is determined by a compression-mode determining device. If the electronic data have been compressed, a selection switch is switched to a switching terminal, and the electronic data are decoded by a decoding device and input to a navigation device. On the other hand, if the electronic data have not been compressed, the electronic data are directly input to the navigation device.

Patent Document 1: Japanese Laid-Open Patent Publication No. H08-320648

### DISCLOSURE OF INVENTION

### Problem to be Solved by the Invention

According to the technology of Patent Document 1 described above, in the compression of the index data, data can be divided into blocks and/or data having values that are within a given range, and can be sorted; however, Patent Document 1 does not describe how to compress map data constituted by drawing data divided into meshes. Consequently, when the map data are divided into blocks and compressed, for example, drawing data for a mountain area with a small amount of data and drawing data for an urban area with a large amount of data are divided into blocks of a similar size. In this case, the compression rate is disadvantageously reduced due to the small amount of data of the drawing data for the mountain area.

It is also a problem that time is required to: (1) retrieve drawing data for an area to be displayed from the map data when data having values that are within a given range, are sorted and compressed; (2) display the map data since the data need to be sorted again after decoding; and (3) decode several blocks since depending on the display area, drawing data to be displayed at once can span several blocks.

### Means for Solving Problem

To solve the above problems and achieve an object, a map-data recording device according to claim 1 records map data in a recording unit, where the map data are constituted by parcel data divided into meshes. The map-data recording device includes a maximum-data-amount obtaining unit that obtains a value indicating a maximum data amount; a setting unit that sets a group by combining the parcel data such that a total amount of data is within the maximum data amount; a compressing unit that collectively compresses the parcel data in units of groups; and a recording control unit that controls the recording unit to record thereto, the parcel data compressed by the compressing unit.

A map displaying device according to claim 9 includes a recording unit that includes the parcel data that constitutes the map data, is compressed and recorded in units of groups by the map-data recording device according to any one of claims 1 to 8; a reading unit that reads out the parcel data by group, from the recording unit; a decoding unit that decodes the parcel data read out by the reading unit; and a display control unit that selects from the parcel data decoded by the decoding unit, parcel data included in a display area and that controls a display unit to display the parcel data.

A map-data recording method according to claim 10 is for a map-data recording device that records map data in a recording unit, where the map data are constituted by parcel data divided into meshes. The map-data recording method includes obtaining a value indicating a maximum data amount; setting a group by combining the parcel data such that a total amount of data is within the maximum data amount; compressing collectively the parcel data in units of groups; and controlling the recording unit to record thereto, the parcel data compressed at the compressing.

A map displaying method according to claim 11 is for a map displaying device that displays a map on a display unit, using a recording unit storing therein the parcel data that constitutes the map data, is compressed and recorded in units of groups through the map-data recording method according to claim 10. The map displaying method includes reading out the parcel data by group, from the recording unit; decoding the parcel data read out at the reading; and selecting from the parcel data decoded at the decoding, parcel data included in a display area and controlling the display unit to display the parcel data.

A map-data recording program according to claim 12 causes a computer to execute the map-data recording method according to claim 10.

A map displaying program according to claim 13 causes a computer to execute the map displaying method according to claim 11.

A recording medium according to claim 14 stores therein the map-data recording program according to claim 12 or the map displaying program according to claim 13 so as to be read by a computer.

### BRIEF DESCRIPTION OF DRAWINGS

FIG. 1 is a block diagram of functional configurations of a map-data recording device and a map displaying device according to an embodiment;

FIG. 2 is a flowchart of a procedure of a map-data recording process performed by the map-data recording device;

FIG. 3 is a flowchart of a procedure of a map displaying process performed by the map displaying device;

FIG. 4 is a block diagram of a hardware configuration of a navigation device according to an example;

FIG. 5 is a schematic of parcel data;

FIG. 6 is a flowchart describing details of a data recording process performed by the navigation device;

FIG. 7 is a flowchart describing details of a map displaying process performed by the navigation device;

FIG. 8 is a schematic of an example of a group setting process;

FIG. 9 is a schematic of another example of the group setting process; and

FIG. 10 is a schematic of still another example of the group setting process.

### EXPLANATIONS OF LETTERS OR NUMERALS

100 map-data recording device

101 recording unit

102 maximum-data-amount obtaining unit

103 maximum-data-number obtaining unit

104 setting unit

105 compressing unit

106 recording control unit

110 map displaying device

111 display unit

112 reading unit

113 decoding unit

114 display control unit

### BEST MODE(S) FOR CARRYING OUT THE INVENTION

A preferred embodiment of a map-data recording device, a map displaying device, a map-data recording method, a map displaying method, a map-data recording program, a map displaying program, and a recording medium according to the present invention will be described with reference to the accompanying drawings.

### Embodiment

### (Functional Configurations of Map-Data Recording Device and Map Displaying Device)

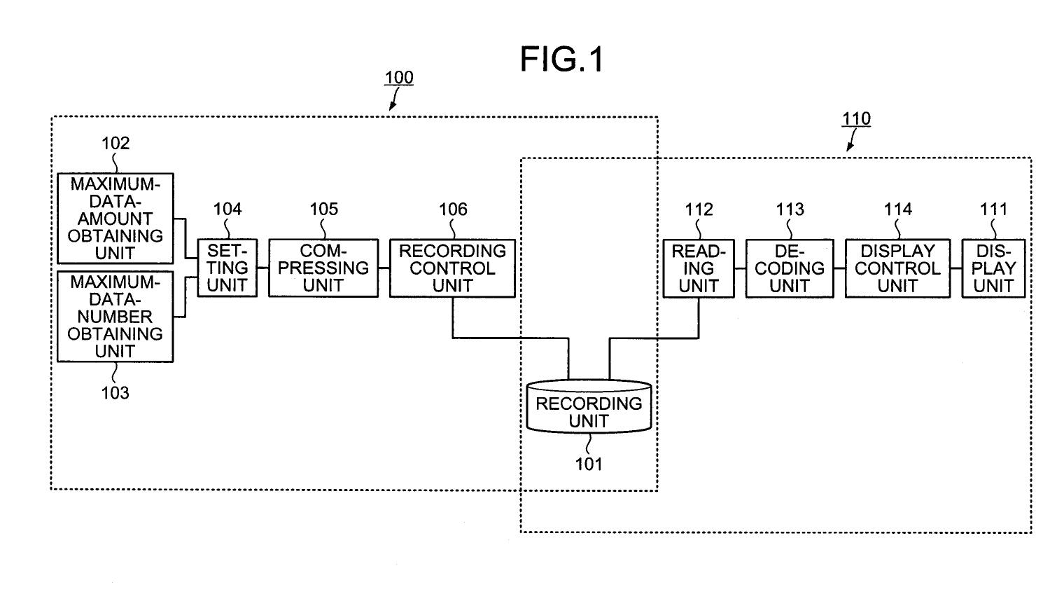

Functional configurations of a map-data recording device 100 and a map displaying device 110 according to an embodiment of the present invention are described. FIG. 1 is a block diagram of functional configurations of the map-data recording device and the map displaying device according to the embodiment.

As depicted in FIG. 1, the map-data recording device 100 includes a recording unit 101, a maximum-data-amount obtaining unit 102, a maximum-data-number obtaining unit 103, a setting unit 104, a compressing unit 105, and a recording control unit 106.

The recording unit 101 records map data constituted by parcel data divided into meshes. The parcel data are drawing data included in the map data. Specifically, the parcel data are constituted by elements such as road data indicative of road shapes, background data representing background screens, character data for displaying characters, etc. The parcel data are divided into given areas according to different scales. The given areas are referred to as meshes, and may be the same size or different sizes according to amount of data for each layer.

The recording unit 101 may employ any recording scheme, and may employ a relational database that can represent the map data in a simple table format, or a conventional file tree structure. The recording unit 101 may be a removable recording medium such as a magnetic disk, an optical disk, a tiny flash memory having a small capacity.

The maximum-data-amount obtaining unit 102 obtains a value indicating the maximum amount of data. The maximum data amount is the upper limit of the total amount of parcel data included in a group set by the setting unit 104 described later. The amount of parcel data differs for each of the parcel data; for example, the amount of data is large for an area where there are many roads and facilities such as an urban area, while the amount of data is small for an area where there are few roads and the background does not change such as a mountain area.

The maximum-data-number obtaining unit 103 obtains a maximum data number indicating the maximum number of parcel data that belong to one group. The maximum data number is the upper limit of the total number of parcel data included in one group set by the setting unit 104 described later. The maximum data number is determined so as to be an optimal number according to the performance of the map displaying device 110 described later. An optimal number is a number that does not cause a group to include many areas other than the area to be displayed, and does not reduce the performance of the map displaying device 110 described later. The optimal number is also a number that causes the amount of data in the group to be larger than the compression rate when each of the parcel data is compressed independently.

The setting unit 104 combines parcel data to set a group such that the total amount of data is within the maximum data amount obtained by the maximum-data-amount obtaining unit 102. The setting unit 104 combines parcel data based on, for example, a geographical condition. The geographical condition is, for example, municipal jurisdiction, geographical shape, or relative positions of parcel data.

The setting unit 104 may combine adjacent parcel data such that an area represented by the parcel data is a rectangle. That is, the setting unit 104 combines adjacent parcel data so as to cover a rectangular area based on the relative positions of parcel data included in the geographical condition. The height to width ratio of the rectangular area, for example, is within a given value. That is, the rectangular area is preferably close to a square. This is because if the height to width ratio of the rectangle is large, for example, a group covering a short height and a long width is set, a scroll of a map in the vertical direction causes groups that include parcel data included in the display area to change frequently, thereby increasing the number of times of decoding and reducing the performance of the map displaying device 110 described later.

The setting unit 104 combines parcel data based on municipal jurisdiction, for example. Specifically, municipal jurisdiction is a prefecture, a local municipality, etc. The setting unit 104 also combines parcel data based on geographical shape, for example. Specifically, the geographical shape is a mountain area or a suburb with relatively few roads and thus with a small amount of data, a flatland area or an urban area with many roads and thus with a large amount of data, etc. The setting unit 104 combines more parcel data when combining parcel data for mountain area or suburb with a small amount of data.

If the map data has a hierarchical structure and map data of each layer are constituted by parcel data divided into meshes set for each layer, the setting unit 104 may combine parcel data of several layers. That is, parcel data of different layers may be combined to set a group.

The setting unit 104 also combines parcel data to set a group such that the number of parcel data is equal to or smaller than the maximum data number obtained by the maximum-data-number obtaining unit 103. For example, even if the total amount of data is within the maximum data amount, the setting unit 104 sets the group such that the number of parcel data does not exceed the maximum data number. This is because if parcel data with a small amount of data are combined, the number of data becomes too many and the group includes much parcel data of areas other than the area to be displayed, thereby reducing the performance of the map displaying device 110 described later.

The compressing unit 105 collectively compresses parcel data in units of groups set by the setting unit 104. In compression, the greater the amount of data to be compressed is, the more the compression rate improves. That is, the greater the total amount of parcel data included in a group is, the more the compression rate improves.

The recording control unit 106 controls the recording unit 101 and records thereto the parcel data compressed by the compressing unit 105.

A functional configuration of the map displaying device 110 according to the embodiment of the present invention is described next. As depicted in FIG. 1, the map displaying device 110 includes the recording unit 101, a display unit 111, a reading unit 112, a decoding unit 113, and a display control unit 114. The map displaying device 110 may be integrated with or independent of the map-data recording device 100. The recording unit 101 includes parcel data constituting the map data, compressed and recorded by the map-data recording device 100 in units of groups.

The display unit 111 includes a display screen that displays the map data. The display screen displays map data of a given display area of a layer according to the scale. If the map displaying device 110 is equipped on a mobile object, the display unit 111 may display a mark indicating the current position of the mobile object on the map data.

The reading unit 112 reads out the parcel data from the recording unit 101 in units of groups. The reading unit 112 reads out, for example, a group(s) that includes parcel data of a display area to be displayed on the display unit 111 from the recording unit 101. When a new display area is specified by user operation such as a scroll and/or a traveling state of the mobile object equipped with the map displaying device 110, the reading unit 112 reads out a group(s) that includes parcel data of the new display area.

The decoding unit 113 decodes the parcel data read out by the reading unit 112. That is, the decoding unit 113 respectively decodes the parcel data read out by the reading unit 112 in units of groups and is in a standby state if, for example, the parcel data of the group read out by the reading unit 112 have been already decoded.

The display control unit 114 selects parcel data included in the display area from the parcel data decoded by the decoding unit 113, and controls the display unit 111 to display the parcel data. If parcel data that have been already decoded are read out by the reading unit 112, the decoding unit 113 may do nothing and the display control unit 114 may display on the display unit 111, the parcel data as they are. The display control unit 114 selects parcel data included in the display area according to, for example, user operation and displays the parcel data on the display unit 111. Alternatively, the display control unit 114 selects parcel data included in the display area according to the traveling state of the mobile object equipped with the map displaying device 110, and displays the parcel data on the display unit 111.

### (Procedure of Map-Data Recording Process Performed by Map-Data Recording Device)

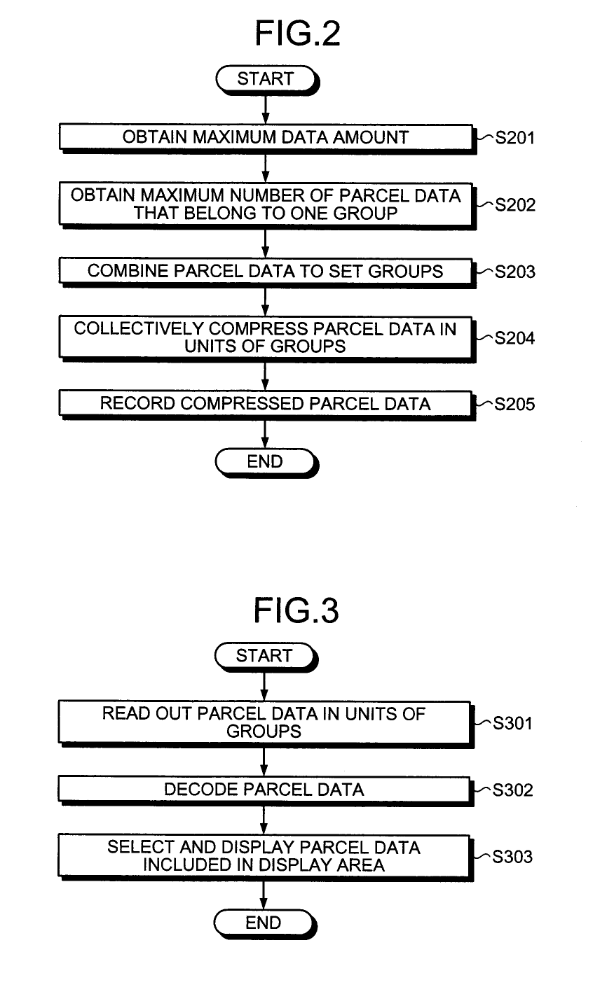

A procedure of a map-data recording process performed by the map-data recording device 100 is described next. FIG. 2 is a flowchart of the procedure of the map-data recording process performed by the map-data recording device. As depicted in the flowchart in FIG. 2, the maximum data amount is obtained by the maximum-data-amount obtaining unit 102 (step S201). The maximum number of parcel data that belong to one group is also obtained by the maximum-data-number obtaining unit 103 (step S202).

Parcel data are combined and groups are set by the setting unit 104 such that the total amount of parcel data is within the maximum data amount and the total number of parcel data is within the maximum data number (step S203). At step S203, adjacent parcel data may be combined such that an area represented by the parcel data is a rectangle. The length to width ratio of the rectangular area may be within a given value.

At step S203, parcel data may be combined based on municipal jurisdiction and/or geographical shape. If the map data has a hierarchical structure and map data of each layer are constituted by parcel data divided into meshes set for each layer, the setting unit 104 may combine parcel data of several layers.

According to the groups set at step S203, the parcel data are collectively compressed by the compressing unit 105 in units of groups (step S204). The parcel data compressed in units of groups at step S204 are recorded in the recording unit 101 by the recording control unit 106 (step S205), ending the sequence of processes.

Although in the flowchart in FIG. 2, the maximum data number is obtained at step S202, for example, parcel data may be combined to set a group based solely on the maximum data amount at step S203, without obtaining the maximum data number.

### (Procedure of Map Displaying Process Performed by Map Displaying Device)

A procedure of a map displaying process performed by the map displaying device 110 is described next. FIG. 3 is a flowchart of the procedure of the map displaying process performed by the map displaying device. In the flowchart of FIG. 3, the recording unit 101 of the map displaying device 110 includes parcel data constituting the map data, compressed and recorded by the map-data recording device 100 in units of groups. As depicted in the flowchart in FIG. 3, the parcel data are read out from the recording unit 101 by the reading unit 112 in units of groups (step S301).

The parcel data read out at step S301 are decoded by the decoding unit 113 (step S302). The parcel data included in the display area are selected by the display control unit 114, from the parcel data decoded at step S302, and the display unit 111 is controlled by the display control unit 114 to display the parcel data (step S303), ending the sequence of processes.

Although in the flowchart in FIG. 3, the parcel data are decoded at step S302, for example, step S302 may be omitted if the parcel data read out at step S301 have been already decoded.

As described above, the map-data recording device 100 according to the embodiment can combine parcel data to set a group by the setting unit 104 such that the total amount of data is within the maximum data amount obtained by the maximum-data-amount obtaining unit 102, and collectively compress the parcel data by the compressing unit 105 in units of groups. The map-data recording device 100 can also control the recording unit 101 by the recording control unit 106 to record therein the compressed parcel data. Thus, the compression rate can be improved by collectively compressing, for example, parcel data with a small amount of data and thus a poor compression rate. Consequently, the user can reduce the volume of the map data.

The map-data recording device 100 according to the embodiment can combine parcel data by the setting unit 104 based on geographical condition. Thus, parcel data that are geographically close to each other can be combined. Consequently, when the map displaying device 110 scrolls parcel data and/or changes the scale, for example, parcel data of the group(s) that has been already read are likely to be reused, thereby improving the performance of displaying the map data.

The map-data recording device 100 according to the embodiment can combine adjacent parcel data by the setting unit 104 such that the area represented by the parcel data is a rectangle. The height to width ratio of the rectangular area can be within a given value. Thus, the area represented by the parcel data can be close to a square. Consequently, the group(s) does not change frequently from one to another even when the map displaying device 110 scrolls parcel data in the vertical or horizontal direction, for example, thereby reducing the number of times of decoding is performed and thus, improving the performance of displaying the map data.

The map-data recording device 100 according to the embodiment can combine parcel data by the setting unit 104, based on municipal jurisdiction. Thus, parcel data are combined to set a group for each prefecture or local municipality, thereby enabling easy management of the groups.

The map-data recording device 100 according to the embodiment can combine parcel data by the setting unit 104 based on geographical shape. Thus, a group can be set by combining relatively more parcel data for mountain areas and/or suburbs, while combining relatively less parcel data for flatland areas and/or urban areas. Consequently, not only the compression rate can be improved by gathering more parcel data for mountain areas and/or suburbs with a small amount of data, but also the time required for the map displaying device 110 to decode parcel data can be reduced, for example, by reducing the number of parcel data for flatland areas and/or urban areas with a large amount of data.

The map-data recording device 100 according to the embodiment can combine parcel data of several layers by the setting unit 104 if the map data has a hierarchical structure and map data of each layer are constituted by parcel data divided into meshes set for each layer. Thus, parcel data of different layers can be collectively compressed. Consequently, when the map displaying device 110 changes the scale of parcel data, for example, parcel data of the group(s) that has been already read are likely to be reused, thereby improving the performance of displaying the map data.

The map-data recording device 100 according to the embodiment can obtain a maximum data number indicative of the maximum number of parcel data that belong to one group by the maximum-data-number obtaining unit 103, and combine parcel data to set a group by the setting unit 104 such that the number of parcel data is equal to or smaller than the maximum data number. Thus, that the occurrence of a group that includes areas other than the area to be displayed can be suppressed. Consequently, for example when displaying the map data, the map displaying device 110 need not decode parcel data for the areas not to be displayed, thereby improving the performance of displaying the map data.

The map displaying device 110 according to the embodiment can read out the parcel data from the recording unit 101, which includes parcel data constituting the map data and compressed and recorded by the map-data recording device 100 in units of groups, by the reading unit 112 in units of groups, and decode the parcel data by the decoding unit 113. The map displaying device 110 can select parcel data included in the display area from the parcel data decoded by the decoding unit 113, and control the display unit 111 to display the parcel data, by the display control unit 114. Thus, parcel data compressed by the map-data recording device 100 in units of groups can be displayed. Consequently, the user can reduce the volume of the map data, and achieve a smooth display of the map data.

### EXAMPLE

An example of the present invention will be described below. In the example, the map-data recording device and the map displaying device of the present invention are implemented by a navigation device equipped on a mobile object such as a vehicle (including four-wheel vehicles and two-wheel vehicles), for example.

### (Hardware Configuration of Navigation Device)

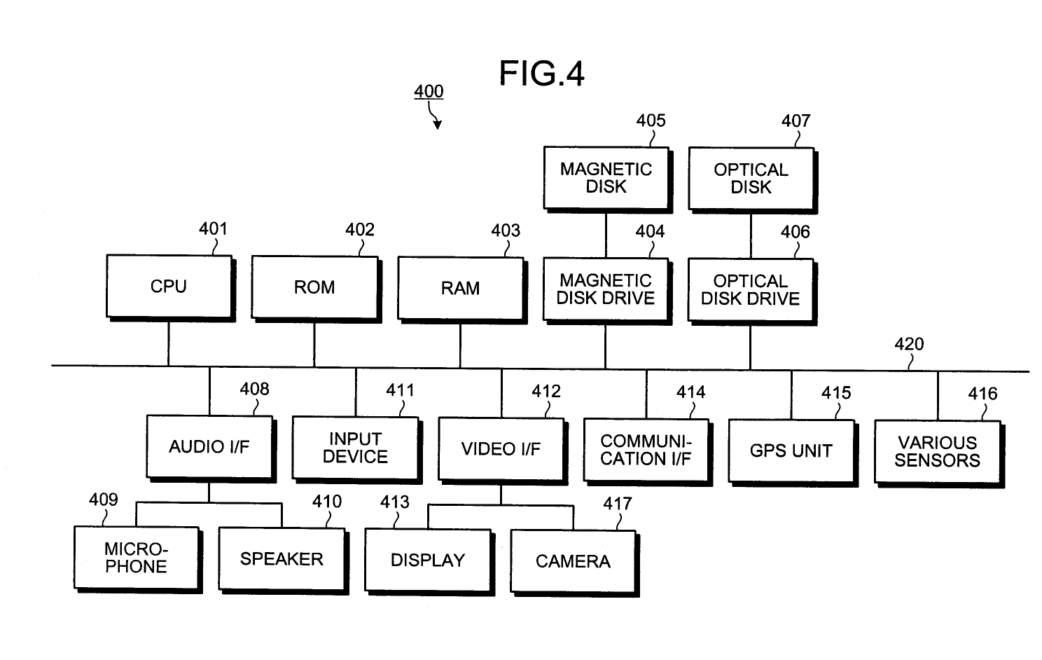

A hardware configuration of a navigation device 400 according to the example will be described. FIG. 4 is a block diagram of a hardware configuration of the navigation device according to the example. As depicted in FIG. 4, the navigation device 400 includes a CPU 401, a ROM 402, a RAM 403, a magnetic disk drive 404, a magnetic disk 405, an optical disk drive 406, an optical disk 407, an audio I/F (interface) 408, a microphone 409, a speaker 410, an input device 411, a video I/F 412, a display 413, a communication I/F 414, a GPS unit 415, various sensors 416, and a camera 417, respectively connected through a bus 420.

The CPU 401 governs overall control of the navigation device 400. The ROM 402 stores therein programs such as a boot program, a data update program, a maximum data amount obtaining program, a maximum data number obtaining program, a geographical-condition obtaining program, a group setting program, a compression program, a display area selection program, and a decode program. The RAM 403 is used as a work area of the CPU 401. The CPU 401 executes various programs stored on the ROM 402 to generally control the navigation device 400, using the RAM 403 as a work area.

The maximum data amount obtaining program causes the maximum data amount to be obtained. The maximum data amount is the upper limit of data of amount of the group set by the group setting program described later. The maximum data amount obtaining program causes a maximum data amount determined according to the performance of the navigation device 400, for example, to be obtained. That is, according to constraints of various programs recorded in the ROM 402 of the navigation device 400 and/or constraints of the magnetic disk 405, the maximum data amount obtaining program causes a maximum data amount that optimizes the performance of the navigation device 400 to be obtained. The maximum data amount obtaining program may cause a maximum data amount to be obtained according to user input, for example.

The maximum data number obtaining program causes a maximum data number indicating the maximum number of parcel data that belong to one group set by the group setting program described later to be obtained. The maximum data number obtaining program causes a maximum data number that does not cause a group to include many areas other than the area the user wants to draw to be obtained.

The geographical-condition obtaining program causes a geographical condition of each of the parcel data to be detected. The geographical condition is, for example, information concerning an area represented by each of the parcel data of the map data such as municipal jurisdiction, geographical shape, etc., or information concerning the relative positions of parcel data. Municipal jurisdiction is information concerning explanation about the area represented by the parcel data such as a prefecture, a local municipality, etc. The geographical shape is information concerning the shape of the area represented by the parcel data such as a mountain area and a flatland area, a suburb and an urban area, etc.

The group setting program causes a group setting process to be executed, the details of which are described later. The group setting program causes the group of parcel data that are to be collectively compressed by the compression program described later to be set. The group setting program causes the group to be set by combining parcel data such that, for example, the total amount of data is within the maximum data amount obtained by the maximum data amount obtaining program. The group setting program also causes the group to be set by combining parcel data such that the number of parcel data is within the maximum data number obtained by the maximum data number obtaining program.

The group setting program causes the group to be set by combining parcel data, based on the geographical condition of each of the parcel data obtained by the geographical-condition obtaining program. Specifically, the group setting program causes the group to be set by combining parcel data of a similar geographical shape or of the same municipal jurisdiction, for example. The group setting program may cause the group to be set by combining adjacent parcel data based on, for example, information concerning the relative positions of parcel data such that the area drawn by the parcel data is a rectangle. In this case, the height to width ratio of the rectangle is preferably within a given value to make the rectangle close to a square. The group setting program may cause the group to be set by combining parcel data of different layers.

The compression program causes parcel data to be collectively compressed in units of groups set by the group setting program, and causes the parcel data compressed in units of groups to be recorded on the magnetic disk 405 and/or the optical disk 407.

The display area selection program causes information concerning the display area of the map data to be obtained. The display area selection program causes parcel data included in the display area to be selected from the parcel data recorded on the magnetic disk 405 and/or the optical disk 407. The display area selection program causes the group(s), into which the parcel data included in the display area are combined, to be selected from the parcel data recorded on the magnetic disk 405 and/or the optical disk 407. The display area is, for example, an area of the map data displayed on the display 413. For example, the display area may be an area within a given distance from the current position of the vehicle or from a point selected by the user.

The decode program causes the parcel data selected by the display area selection program to be decoded. That is, the decode program causes parcel data of the group(s) that includes the parcel data selected by the display area selection program to be collectively decoded.

The magnetic disk drive 404 controls the reading/writing of data with respect to the magnetic disk 405 under the control of the CPU 401. The magnetic disk 405 records the data written under the control of the magnetic disk drive 404. The magnetic disk 405 may be HD (hard disk) or FD (flexible disk), for example.

The optical disk drive 406 controls the reading and writing of data with respect to the optical disk 407 under the control of the CPU 401. The optical disk 407 is a removable recording medium from which data is read out under the control of the optical disk drive 406. A writable recording medium may be utilized for the optical disk 407. The removable recording medium may be a medium other than the optical disk 407, such as an MO and a memory card.

Exemplary information recorded on the magnetic disk 405 and the optical disk 407 includes map data. The magnetic disk 405 and the optical disk 407 may employ any recording scheme, and parcel data and region data constituting the map data are recorded for each mesh in a relational database (RDB) and/or a file tree structure. That is, the map data are constituted by parcel data and region data divided into meshes.

The parcel data are drawing data and constituted by elements such as road data indicative of road shapes, background data representing features such as buildings, rivers, and ground surfaces, character data for displaying character(s), etc. The region data are data for route calculation, and specifically, are data of road network including links and nodes. Both the parcel data and the region data have a hierarchical structure.

The audio I/F 408 is connected to the microphone 409 for audio input and the speaker 410 for audio output. Sounds received by the microphone 409 are A/D-converted within the audio I/F 408. The microphone 409 is disposed near a sun visor of the vehicle and one or more of the microphones 409 may be disposed. The speaker 410 outputs sounds of predetermined audio signals subjected to D/A conversion in the audio I/F 408. The sounds input from the microphone 409 may be recorded as audio data on the magnetic disk 405 or the optical disk 407.

The input device 411 includes a remote controller having keys for entering characters, numeric values, and various instructions; a keyboard; a touch panel; etc. The input device 411 may be implemented in single form such as a remote controller, a keyboard, and a touch panel, or may be implemented in multiple forms.

The video I/F 412 is connected to the display 413. Specifically, the video I/F 412 is made up of, for example, a graphic controller that generally controls the display 413, a buffer memory such as VRAM (Video RAM) that temporarily records immediately displayable image information, and a control IC that controls the display 413, based on image data output from a graphic controller.

The display 413 displays icons, cursors, menus, windows, or various data such as characters and images. The display 413 draws the above map data two-dimensionally or three-dimensionally. The map data displayed on the display 413 can be superimposed with a mark, etc. representative of the current position of the vehicle equipped with the navigation device 400. The current position of the vehicle is calculated by the CPU 401.

For example, a CRT, a TFT liquid crystal display, a plasma display, etc., may be employed as the display 413. The display 413 is disposed near the dashboard of the vehicle. The display 413 may be disposed in plural in the vehicle in such a way that the displays are disposed in the vicinity of the backseat of the vehicle as well as near the dashboard of the vehicle.

The communication I/F 414 is wirelessly connected to a network and functions as an interface between the navigation device 400 and the CPU 401. The communication I/F 414 is wirelessly connected to a communication network such as the Internet and also functions as an interface between this communication network and the CPU 401.

The communication network includes LAN, WAN, public line network, portable telephone network, etc. Specifically, the communication I/F 414 is made up of, for example, an FM tuner, VICS (Vehicle Information and Communication System)/beacon receiver, a radio navigation device, and other navigation devices and acquires road traffic information, such as road congestion and traffic regulations, distributed from VICS centers. VICS is a registered trademark. The communication I/F 414 is made up of an in-vehicle radio device for bidirectional communication with a roadside radio device when, for example, a DSRC (Dedicated Short Range Communication) is employed and obtains various information such as traffic information and map information. A specific example of DSRC is ETC (non-stop automatic toll correction system).

The GPS unit 415 receives signals from GPS satellites and outputs information indicative of the current position of the vehicle. The information output from the GPS unit 415 is used along with values output from the various sensors 416 (described hereinafter) when the CPU 401 calculates the current position of the vehicle. The information indicative of the current position is information specifying one point on the map data, for example, latitude/longitude and altitude.

The various sensors 416 such as a vehicular speed sensor, an acceleration sensor, and an angular-speed sensor output information for determining the position and behavior of the vehicle. The values output from the various sensors 416 are used by the CPU 401 to calculate the current position of the vehicle and changes in velocity and direction.

The camera 417 captures images inside or outside the vehicle. The images may be still images or moving images and, for example, the camera 417 captures images of behaviors of a passenger inside the vehicle and outputs the captured images to a recording medium such as the magnetic disk 405 and the optical disk 407 through the video I/F 412. The camera 417 captures images of conditions outside the vehicle and outputs the captured images to the recording medium such as the magnetic disk 405 and the optical disk 407 through the video I/F 412. The camera 417 has an infrared camera function and distributions of surface temperatures of objects present inside the vehicle may relatively be compared based on the image information captured with the use of the infrared camera function. The images output to the recording medium are overwritten and saved.

Functions of the recording unit 101, the maximum-data-amount obtaining unit 102, the maximum-data-number obtaining unit 103, the setting unit 104, the compressing unit 105, and the recording control unit 106 included in the map-data recording device 100 depicted in FIG. 1, and functions of the recording unit 101, the display unit 111, the reading unit 112, the decoding unit 113, and the display control unit 114 included in the map displaying device 110 are implemented by the CPU 401 executing a given program and controlling each unit of the navigation device 400 using programs/data recorded in the ROM 402, the RAM 403, the magnetic disk 405, and the optical disk 407, etc., of the navigation device 400 depicted in FIG. 4.

In other words, the navigation device 400 according to the example can execute the functions of the map-data recording device 100 or the map displaying device 110 depicted in FIG. 1 according to the procedure of map-data recording process or the procedure of map displaying process depicted in FIGS. 2 and 3, respectively, by executing the map-data recording program or the map displaying program recorded in the ROM 402 as a recording medium of the navigation device 400.

### (Parcel Data)

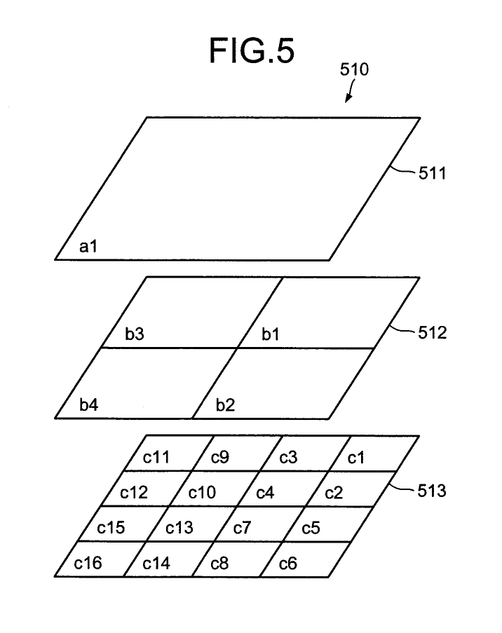

The parcel data is described next with reference to FIG. 5. FIG. 5 is a schematic of parcel data. In FIG. 5, a sign 510 indicates the map data. The map data 510 includes, for example, broad-view data 511, medium-view data 512, and detailed-view data 513, and has a hierarchical structure. The broad-view data 511 include parcel data al. The medium-view data 512 include parcel data divided into b1 to b4. The detailed-view data 513 include parcel data divided into C1 to C16. For example, the parcel data c1 to c4 belong to the layer of b1, the parcel data c5 to c8 belong to the layer of b2, the parcel data c9 to c12 belong to the layer of b3, the parcel data c13 to c16 belong to the layer of b4, and the parcel data b1 to b4 belong to the layer of al. Although the parcel data are described here, the same applies to the region data.

### (Details of Data Recording Process Performed by Navigation Device)

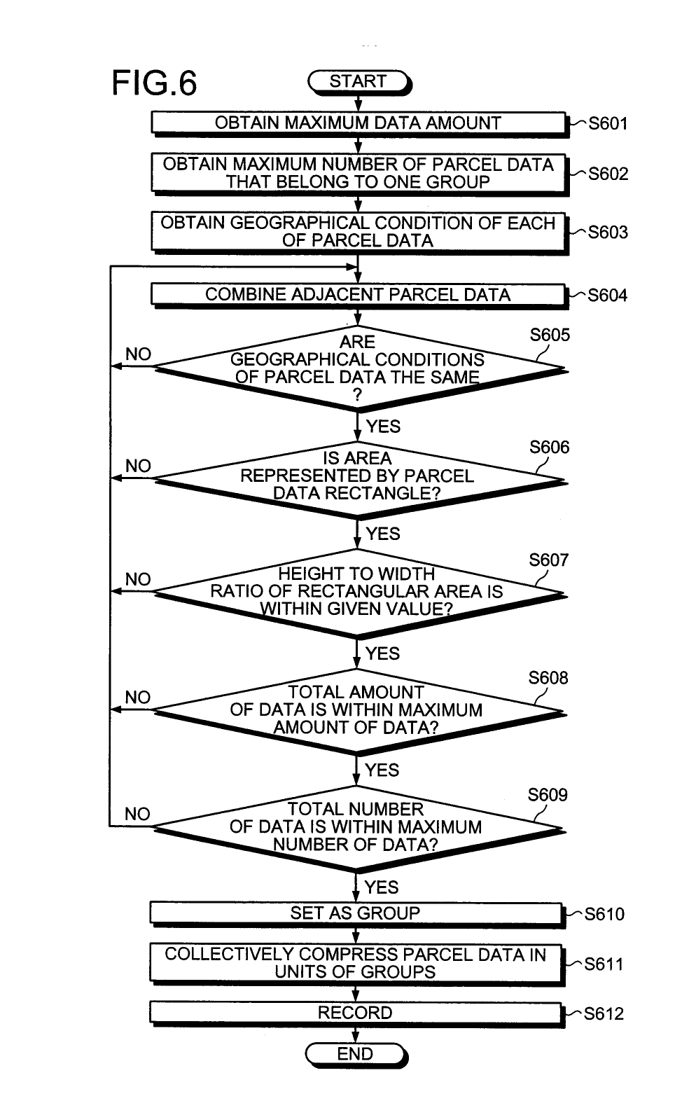

Details of a data recording process performed by the navigation device 400 are described next. FIG. 6 is a flowchart describing the details of the data recording process performed by the navigation device. As depicted in FIG. 6, the maximum data amount obtaining program is executed to obtain the maximum data amount (step S601). The maximum data number obtaining program is executed to obtain the maximum number of parcel data that belong to one group (step S602).

The geographical-condition obtaining program is executed to obtain a geographical condition of each of the parcel data (step S603). A geographical condition is, for example, municipal jurisdiction such as a prefecture, a local municipality, etc.; a geographical shape such as a mountain area and a flatland area, a suburb and an urban area, etc.; and relative positions of parcel data. Based on the geographical condition obtained at step S603, adjacent parcel data are combined (step S604). At step S604, several adjacent parcel data may be combined.

Based on the geographical condition of each of the parcel data obtained at step S603, it is determined whether geographical conditions of parcel data combined at step S604 are the same (step S605). If the geographical conditions are determined to be the same at step S605 (step S605: YES), it is determined whether an area represented by the combined parcel data is a rectangle (step S606). If the area represented by the parcel data is determined to be a rectangle at step S606 (step S606: YES), it is determined whether the height to width ratio of the rectangular area is within a given value (step S607).

If the height to width ratio of the rectangular area is determined to be within the given value at step S607 (step S607: YES), it is determined whether the total amount of the combined parcel data is within the maximum data amount obtained at step S601 (step S608). If the total amount of data is within the maximum data amount at step S608 (step S608: YES), it is determined whether the total number of the combined parcel data is within the maximum data number obtained at step S602 (step S609).

If the total number is determined to be within the maximum data number at step S609 (step S609: YES), the combined parcel data are set as a group (step S610). The parcel data are collectively compressed in units of groups set at step S610 (step S611). The parcel data compressed in units of groups at step S611 are recorded on the magnetic disk 405, the optical disk 407, etc. (step S612), ending the sequence of processes.

On the other hand, if it is determined that the geographical conditions of the parcel data are not the same at step S605 (step S605: NO), the area represented by the parcel data is not a rectangle at step S606 (step S606: NO), or the height to width ratio of this rectangular area is not within the given value (step S607: NO), the process returns to step S604 and subsequent processes are repeated. Similarly, if the total amount of the combined parcel data is not within the maximum data amount at step S608 (step S608: NO), or the total number of the combined parcel data is not within the maximum data number at step S609 (step S609: NO), the process returns to step S604 and subsequent processes are repeated.

Although in the flowchart in FIG. 6, the maximum number of parcel data that belong to one group is obtained at step S602, for example, step S602 may be omitted. In this case, step S609 is also omitted.

Although in the flowchart in FIG. 6, it is determined whether the area represented by the parcel data is a rectangle at step S606, for example, the area may not be a complete rectangle as long as being close to a rectangle, for example. In this case, step S607 may be omitted.

In the flowchart of FIG. 6, the order in which processes at steps S605 to S609 are performed is arbitrary, and it is sufficient to execute at least one of steps S605 to S609.

### (Details of Map Displaying Process Performed by Navigation Device)

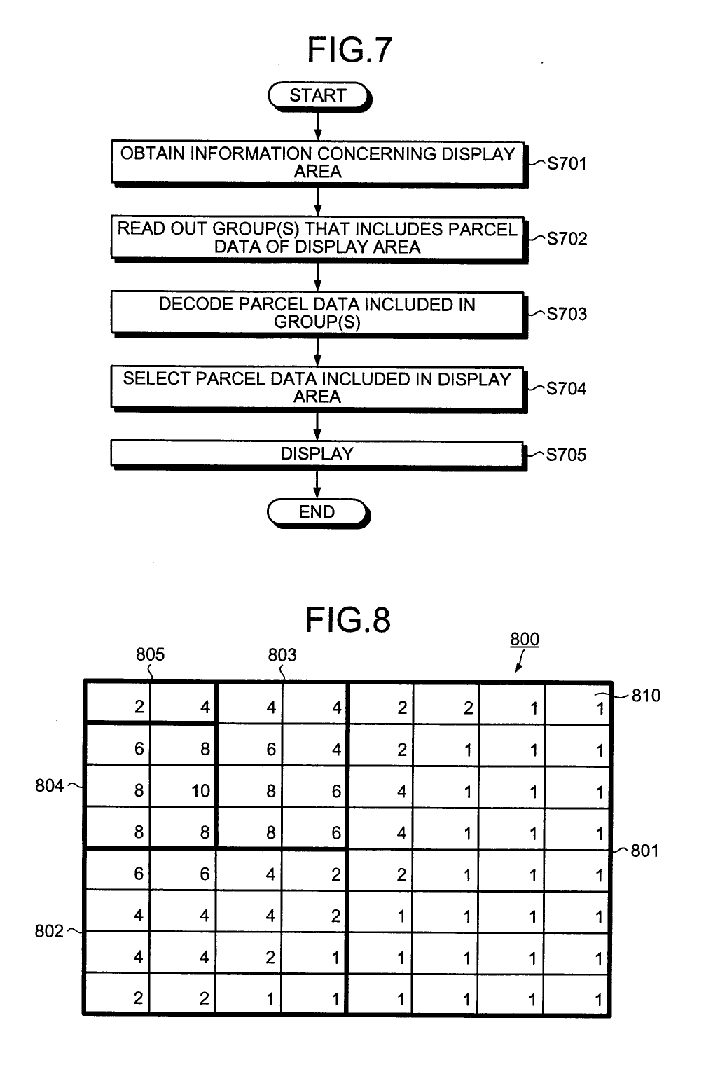

Details of a map displaying process performed by the navigation device are described next. FIG. 7 is a flowchart describing details of the map displaying process performed by the navigation device. As depicted in FIG. 7, the display area selection program is executed to obtain information concerning the display area (step S701). Based on the information concerning the display area obtained at step S701, a group(s) that includes parcel data of the display area is read out from the magnetic disk 405 or the optical disk 407 (step S702).

The parcel data included in the group(s) read out at step S702 are decoded (step S703). From the parcel data decoded at step S703, parcel data included in the display area are selected (step S704), and the selected parcel data are displayed on the display 413 (step S705), ending the sequence of processes.

Although in the flowchart in FIG. 7, the group(s) that includes the parcel data of the display area is read out at step S702 and the parcel data included therein are decoded at step S703, for example, step S703 may be omitted if the group(s) that includes the parcel data of the display area read out at step S702 has been already decoded.

### (Example of Group Setting Process)

An example of a group setting process is described next with reference to FIG. 8. FIG. 8 is a schematic of an example of the group setting process. With reference to FIG. 8, a case in which map data 800 are constituted by 64 (=8×8) parcel data 810 is described. In FIG. 8, the numeric value depicted in each of the parcel data 810 indicates the amount of data thereof in units of kilobytes (KB), for example. Here, if the maximum data amount is 50 KB, adjacent parcel data 810 are combined such that the total amount of data is 50 KB or less. In FIG. 8, the area represented by parcel data 810 included in each group is a rectangle of which the height to width ratio is within a given value (for example, 1:2 or 2:1).

As depicted in FIG. 8, the parcel data 810 included in the map data 800 are combined to set the first group 801 to the fifth group 805. The total amount of data of the first group 801 is 42 KB, and the number of parcel data thereof is 32. The total amount of data of the second group 802 is 49 KB, and the number of parcel data thereof is 16. The total amount of data of the third group 803 is 46 KB, and the number of parcel data thereof is 8. The total amount of data of the fourth group 804 is 48 KB, and the number of parcel data thereof is 6. The total amount of data of the fifth group 805 is 6 KB, and the number of parcel data thereof is 2.

As described above, the amount of data of each of the first group 801 to the fifth group 805 is 50 KB or less, and the area represented by the parcel data 810 included therein is a rectangle. If the maximum number of parcel data is 20, for example, the first group 801 is divided into two groups each of which includes 16 (=4×4) parcel data 810 and has a height to width ratio that does not exceed 1:2 or 2:1.

The maximum data amount, the maximum data number, and the height to width ratio of the rectangle may be arbitral and changeable according to the performance of the navigation device 400 and user operation.

### (Another Example of Group Setting Process)

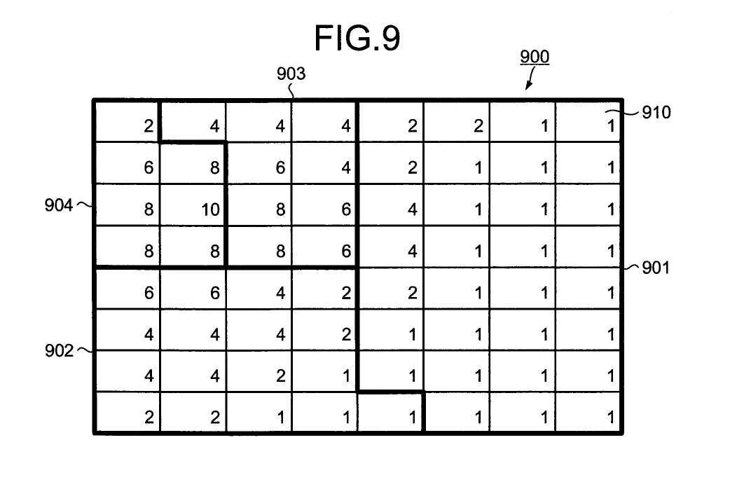

Another example of the group setting process is described next with reference to FIG. 9. FIG. 9 is a schematic of another example of the group setting process. In FIG. 9, map data 900 are constituted by 64 (=8×8) parcel data 910. The parcel data 910 depicted in FIG. 9 has the same configuration as the parcel data 810 of the map data 800 depicted in FIG. 8. As depicted in FIG. 9, the shape of the group may not be a complete rectangle as long as being close to a rectangle and as long as the maximum data amount is within 50 KB. Thus, the amount of data of each group can be brought closer to the maximum data amount.

Specifically, the total amount of data of the first group 901 is 41 KB, and the number of parcel data thereof is 31. The total amount of data of the second group 902 is 50 KB, and the number of parcel data thereof is 17. The total amount of data of the third group 903 is 50 KB, and the number of parcel data thereof is 9. The total amount of data of the fourth group 904 is 50 KB, and the number of parcel data thereof is 7. As described above, compared to the map data 800 depicted in FIG. 8, the number of groups of the map data 900 depicted in FIG. 9 has been reduced by one and the total amount of data for the second group 902 to the fourth group 904 have been increased, respectively.

### (Still Another Example of Group Setting Process)

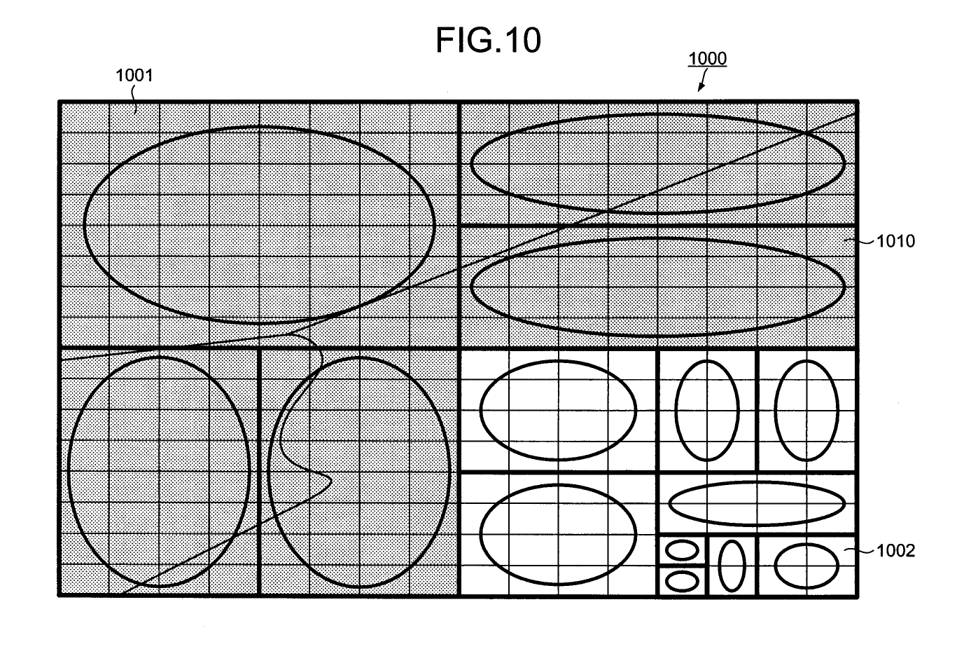

Still another example of the group setting process is described next with reference to FIG. 10. FIG. 10 is a schematic of still another example of the group setting process. With reference to FIG. 10, a case in which map data 1000 are constituted by 256 (=16×16) parcel data 1010 is described. In FIG. 10, a hatched portion of the parcel data 1010 represents a mountain area or suburb 1001, while a non-hatched portion represents a flatland area or urban area 1002.

The amount of each of the parcel data 1010 is small in the mountain area or suburb 1001 where there are few roads and the background does not change. On the other hand, the amount of each of the parcel data 1010 is large in the flatland area or urban area 1002 where there are many roads and facilities. Thus, groups (areas enclosed by heavy solid lines in the figure) are set by combining a relatively large number of parcel data 1010 of the mountain area or suburb 1001 and/or a relatively small number of parcel data 1010 of the flatland area or urban area 1002.

As described above, the navigation device 400 according to the example can set groups by combining parcel data that is for drawing and constitutes the map data, based on the amount of data, the number of data, and/or the geographical condition thereof. That is, a group can be set by combining a relatively large number of parcel data with a small amount of data and/or a relatively small number of parcel data with a large amount of data. The parcel data can be collectively compressed in units of groups, and recorded on the magnetic disk 405 or the optical disk 407. Thus, more data can be compressed compared to compressing each of the parcel data independently, thereby improving the compression rate of the map data. Thus, the user can reduce the volume of the map data recorded on the magnetic disk 405 or the optical disk 407.

The navigation device 400 can further read out, decode, and display on the display 413, the group(s) that includes the parcel data of the display area of the map data, such as an area within a given distance from the current position of the vehicle or from a point selected by the user. The navigation device 400 can display the parcel data as they are if the parcel data of the display area are included in a group(s) that has been already decoded. Thus, parcel data having a similar geographical condition can be correctively decoded, thereby enabling already-decoded parcel data to be used when the map data are scrolled or the scale is changed. Consequently, the number of times parcel data is decoded is reduced, thereby improving the performance of displaying the map. Thus, the user can achieve a smooth display of the map data.

As described above, the map-data recording device, the map displaying device, the map-data recording method, the map displaying method, the map-data recording program, the map displaying program, and the recording medium according to the present invention can improve the compression rate of the map data and the performance of the map displaying process by combining and compressing parcel data according to the amount of each of the parcel data constituting the map data.

The map-data recording method and the map displaying method described in the embodiment may be implemented by executing a preliminarily prepared program, the program being executed by a computer such as a personal computer, a workstation, and a mobile terminal (mobile phone). The program is recorded on a computer-readable recording medium such as a hard disk, a flexible disk, a CD-ROM, an MO, and a DVD and is read from the recording medium by the computer for execution. The program may be a transmission medium distributable through a network such as the Internet.

1-14. (canceled)

15. A map-data recording device that records map data in a recording unit, wherein the map data are constituted by parcel data divided into meshes, the map-data recording device comprising:
a maximum-data-amount obtaining unit that obtains a value indicating a maximum data amount;
a setting unit that sets a group by combining the parcel data such that a total amount of data is within the maximum data amount;
a compressing unit that collectively compresses the parcel data in units of groups; and
a recording control unit that controls the recording unit to record thereto, the parcel data compressed by the compressing unit.

16. The map-data recording device according to claim 15, wherein the setting unit combines the parcel data, based on geographical condition.

17. The map-data recording device according to claim 16, wherein the setting unit combines adjacent parcel data such that an area represented by the combined parcel data is rectangular.

18. The map-data recording device according to claim 17, wherein a height to width ratio of the rectangular area is within a given value.

19. The map-data recording device according to claim 16, wherein the setting unit combines the parcel data, based on municipal jurisdiction.

20. The map-data recording device according to claim 16, wherein the setting unit combines the parcel data, based on geographical shape.

21. The map-data recording device according to claim 15, wherein
the map data has a hierarchical structure and the map data of each layer are constituted by the parcel data divided into meshes set for each layer, and
the setting unit combines the parcel data of several layers.

22. The map-data recording device according to claim 15, further comprising a maximum-data-number obtaining unit configured to obtain a maximum data number indicating a maximum number of parcel data that belong to one group, wherein
the setting unit sets a group by combining the parcel data such that the combined parcel data are of a number that is equal to or smaller than the maximum data number.

23. A map displaying device comprising:
a recording unit that includes the parcel data that constitutes the map data, is compressed and recorded in units of groups by the map-data recording device according to claim 15;
a reading unit that reads out the parcel data by group, from the recording unit;
a decoding unit that decodes the parcel data read out by the reading unit; and
a display control unit that selects from the parcel data decoded by the decoding unit, parcel data included in a display area and that controls a display unit to display the parcel data.

24. A map-data recording method for a map-data recording device that records map data in a recording unit, wherein the map data are constituted by parcel data divided into meshes, the map-data recording method comprising:
obtaining a value indicating a maximum data amount;
setting a group by combining the parcel data such that a total amount of data is within the maximum data amount;
compressing collectively the parcel data in units of groups; and
controlling the recording unit to record thereto, the parcel data compressed at the compressing.

25. A map displaying method for a map displaying device that displays a map on a display unit using a recording unit storing therein the parcel data that constitutes the map data, is compressed and recorded in units of groups through the map-data recording method according to claim 24, the map displaying method comprising:
reading out the parcel data by group, from the recording unit;
decoding the parcel data read out at the reading; and
selecting from the parcel data decoded at the decoding, parcel data included in a display area and controlling the display unit to display the parcel data.

26. A non-transitory, computer-readable recording medium storing therein a map-data recording program that causes a computer to execute the map-data recording method according to claim 24.

27. A non-transitory, computer-readable recording medium storing therein map displaying program that causes a computer to execute the map displaying method according to claim 25.
